(19) United States
(12) Patent Application Publication
(10) Pub. No.: US 2021/0325859 A1
(43) Pub. Date: Oct. 21, 2021

(54) CONTROL METHOD AND CONTROL DEVICE OF FABRICATION EQUIPMENT

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Lilei Yan, Shenzhen, Guangdong (CN)

(21) Appl. No.: 16/622,591

(22) PCT Filed: Dec. 5, 2019
(86) PCT No.: PCT/CN2019/123151

§ 371 Date: Dec. 13, 2019

(30) Foreign Application Priority Data
Nov. 14, 2019 (CN) 201911110083.9

(51) Int. Cl. G05B 19/418

(52) U.S. Cl. CPC G05B 19/41875; G05B 19/41865; G05B 19/4183

(57) ABSTRACT

A control method and a control device of fabrication equipment are provided. The method includes: when defects existing on the display panels are detected, determining a category of the defects belonging to, and obtaining a number of each of the detects to obtain a plurality of detection data; obtaining a total of each of the defects existing on the display panels manufactured by each of the fabrication equipment according to the plurality of detection data; judging whether an exception occurring on the fabrication equipment according to the total of each defect to perform exception handling on the fabrication equipment.

### CROSS-REFERENCE TO RELATED APPLICATIONS

This application is the National phase under 35 U.S.C. § 371 of International Application No. PCT/CN2019/123151, filed Dec. 5, 2019, which claims the benefit of and priority to Chinese Patent Application No. 201911110083.9, filed Nov. 14, 2019. The entire contents of these patent applications are hereby incorporated by reference herein.

### FIELD OF INVENTION

The present disclosure relates to the field of display technology, and particularly relates to a control method and a control device of fabrication equipment.

### BACKGROUND OF INVENTION

Currently, when defects are detected by detecting equipment, the detects are analyzed by humans to judge whether an exception occurs on fabrication equipment. If the exception occurs, the fabrication equipment having exception is turned off by the humans.

However, when there are too much defects, the humans cannot handle the plurality of defects in time. Therefore, it is easy to make unqualified panels go into subsequent processes, which wastes fabrication material. Moreover, because the fabrication equipment having the exception cannot be turned off, a number of scrapping panels is increased, causing product yield to be low.

Therefore, it is necessary to provide a control method and a control device of fabrication equipment to solve the problem exists in the prior art.

### SUMMARY OF INVENTION

The purpose of the present disclosure is to provide a control method and a control device of fabrication equipment, which can improve product yield.

In order to solve the technical problem mentioned above, the present disclosure provides a control method of fabrication equipment, including:

Detecting each display panel manufactured by each of the fabrication equipment in a preset duration, when defects existing on the display panels are detected, determining a category of the defects belonging to, and obtaining a number of each of the detects to obtain a plurality of detection data, and each of the display panel corresponds to one of the detection data.

Obtaining a total of setting defects existing on the display panels manufactured by each of the fabrication equipment according to the plurality of detection data.

Obtaining a total of the display panels manufactured by each of the fabrication equipment in the preset duration to obtain a panel amount.

Judging whether an exception occurring on the fabrication equipment according to the total of the setting defects and the panel amount.

If the exception occurs on the fabrication equipment, turning off the fabrication equipment, or the fabrication equipment can be controlled to intercept the display panel being manufactured currently.

The present disclosure further provides a control method of fabrication equipment, including:

Detecting each display panel manufactured by each of the fabrication equipment in a preset duration, when defects existing on the display panels are detected, determining a category of the defects belonging to, and obtaining a number of each of the detects to obtain a plurality of detection data, and each of the display panel corresponds to one of the detection data.

Obtaining a total of each of the defects existing on the display panels manufactured by each of the fabrication equipment according to the plurality of detection data.

Judging whether an exception occurring on the fabrication equipment according to the total of each defect.

If the exception occurs on the fabrication equipment, performing exception handling on the fabrication equipment.

The present disclosure further provides a control device of fabrication equipment, including:

A detection module, which is used for detecting each display panel manufactured by each of the fabrication equipment in a preset duration, when defects existing on the display panels are detected, determining a category of the defects belonging to, and obtaining a number of each of the detects to obtain a plurality of detection data, and each of the display panel corresponds to one of the detection data.

An obtaining module, which is used for obtaining a total of each of the defects existing on the display panels manufactured by each of the fabrication equipment according to the plurality of detection data.

A judging module, which is used for judging whether an exception occurring on the fabrication equipment according to the total of each defect.

A control module, which is used for performing exception handling on the fabrication equipment when the exception occurs on the fabrication equipment.

The control device of the fabrication equipment includes: when defects existing on the display panels are detected, determining a category of the defects belonging to, and obtaining a number of each of the detects to obtain a plurality of detection data; obtaining a total of each of the defects existing on the display panels manufactured by each of the fabrication equipment according to the plurality of detection data; judging whether an exception occurring on the fabrication equipment according to the total of each defect. If the exception occurs on the fabrication equipment, performing exception handling on the fabrication equipment. Because the present disclosure can detect the fabrication equipment having the exception automatedly, it can prevent from waste of material. When the equipment is abnormal, it is turned off, or the display panel is intercepted, thereby reducing a scrapping rate of the panels and improving product yield.

### DESCRIPTION OF DRAWINGS

FIG. 1 is a flowchart of a control method of fabrication equipment of a first embodiment of the present disclosure.

FIG. 2 is a flowchart of a control method of the fabrication equipment of a second embodiment of the present disclosure.

FIG. 3 is a structural schematic diagram of a control device of the fabrication equipment of the present disclosure.

FIG. 4 is a preferred structural schematic diagram of the control device of the fabrication equipment of the present disclosure.

FIG. 5 is a structural schematic diagram of a control system of the fabrication equipment of the present disclosure.

### DETAILED DESCRIPTION OF PREFERRED EMBODIMENTS

The descriptions of embodiments below refer to accompanying drawings in order to illustrate certain embodiments which the present disclosure can implement. The directional terms of which the present disclosure mentions, for example, “top”, “bottom”, “front”, “rear”, “left”, “right”, “inside”, “side”, etc., are only refer to directions of the accompanying figures. Therefore, the used directional terms are for illustrating and understanding the present disclosure, but not for limiting the present disclosure. In the figures, units with similar structures are indicated by the same reference numerals.

The terms “first”, “second”, etc. in the specification, claims, and the accompanying drawings mentioned above of the present disclosure are used to distinguish similar objects, and are not used to describe a particular order. Moreover, the terms “comprising” and “having” and any deformation of them are intended to cover non-exclusive inclusions.

Devices of panel fabrication include various fabrication equipment, and each of the fabrication equipment can manufacture a plurality of display panels.

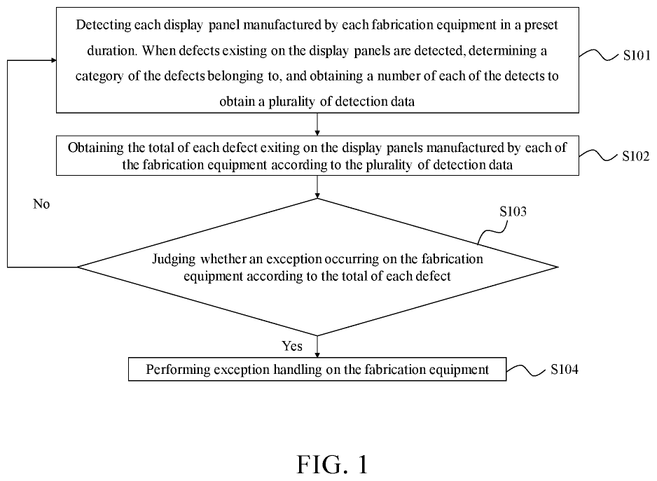

As illustrated in FIG. 1, a control method of fabrication equipment of an embodiment includes:

S101, detecting each display panel manufactured by each of the fabrication equipment in a preset duration. When defects existing on the display panels are detected, determining a category of the defects belonging to, and obtaining a number of each of the detects to obtain a plurality of detection data.

For example, each of the fabrication equipment manufactures the plurality of display panels in the preset duration, and each display panel is detected by detecting equipment. When defects existing on the display panel are detected, determining which kind of defects are the defects belonging to, and determining a number of each of the detects to obtain the plurality of detection data. Each of the display panel corresponds to one of the detection data.

When the defects existing on the display panels are detected, the method may further include: obtaining positional information of the defects.

That is, the detection data may further include the positional information of the detection data, and for example, the positional information can be the coordinates of the defects.

For example, categories of the defects include scrapes and corrosion, and a number of the scrapes detected on the display panel is three, and a number of the corrosion detected on the display panel is six.

In an embodiment, each of the detection data relates to identification numbers of the display panels, and the identification numbers of the display panels relate to identification numbers of the fabrication equipment.

S102, obtaining the total of each defect exiting on the display panels manufactured by each of the fabrication equipment according to the plurality of detection data.

For example, computing to obtain the total of each defect exiting on all the display panels manufactured by each of the fabrication equipment according to the detection data obtained in the step S101. For example, fabrication equipment A, which manufactures five display panels. A total of scrapes and a total of corrosion existing on the five display panels in the fabrication equipment A is computed.

The step of obtaining each defect of each display panel of each of the fabrication equipment according to the plurality of detection data includes:

S1021, obtaining identification numbers of the display panels corresponding to each of the fabrication equipment to obtain a plurality of target identification numbers.

For example, obtaining identification numbers of each of the fabrication equipment, and obtaining identification numbers of the corresponding display panels according to the identification numbers of each of the fabrication equipment. For example, serial numbers of the display panels correspond to the fabrication equipment are from P1 to P5.

S1022, obtaining the detection data corresponding to each of the target identification numbers.

For example, respectively obtaining the detection data corresponding from P1 to P5.

S1023, computing a sum of the numbers of each defect in the detection data.

For example, respectively computing a sum of the numbers of each defect from P1 to P5, that is, a total number of each defect from P1 to P5.

S103, judging whether an exception occurring on the fabrication equipment according to the total of each defect.

For example, judging whether the exception occurring on the fabrication equipment according to the total of the scrapes and the total of corrosion existing on the five display panels in the fabrication equipment A.

For example, in an embodiment, the total of the scrapes and the total of the corrosion can be compared to a preset value, and if one of which is greater than the preset value, the fabrication equipment A is judged to be abnormal. Of course, it can be understood that in another embodiment, an average of the total of the scrapes and the total of the corrosion can be obtained, and when the average is greater than the preset value, the fabrication equipment A is judged to be abnormal. In can be understood that the method of judging whether the fabrication equipment is abnormal is not limited thereto. When the exception not occurring on the fabrication equipment A is determined, returning to the step S101.

S104, if the exception occurs on the fabrication equipment, performing exception handling on the fabrication equipment.

For example, when the exception occurring on the fabrication equipment A is determined, the fabrication equipment can be turned off, or the fabrication equipment can be controlled to intercept the display panel being manufactured currently.

The control method of the fabrication equipment includes: when defects existing on the display panels are detected, determining a category of the defects belonging to, and obtaining a number of each of the detects to obtain a plurality of detection data; obtaining the total of each defect exiting on the display panels manufactured by each of the fabrication equipment according to the plurality of detection data; judging whether an exception occurring on the fabrication equipment according to the total of each defect. If the exception occurs on the fabrication equipment, performing exception handling on the fabrication equipment. Because the present disclosure can detect the fabrication equipment having the exception automatedly, it can prevent from waste of material. When the equipment is abnormal, it is turned off, or the display panel is intercepted, thereby reducing a scrapping rate of the panels and improving product yield.

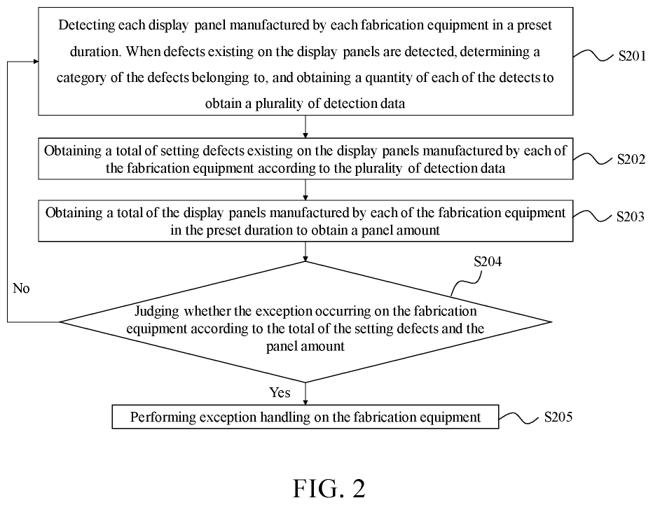

As illustrated in FIG. 2, a control method of the fabrication equipment of the equipment includes:

S201, detecting each display panel manufactured by each fabrication equipment in a preset duration. When defects existing on the display panels are detected, determining a category of the defects belonging to, and obtaining a number of each of the detects to obtain a plurality of detection data.

For example, the fabrication equipment includes fabrication equipment A and fabrication equipment B. The fabrication equipment A manufacture five display panels in the preset duration, and the fabrication equipment B manufacture ten display panels in the preset duration. Each display panel in the fabrication equipment A and each display panel of the fabrication equipment B are detected by detecting equipment. When defects existing on the display panel are detected, determining which kind of defects are the defects belonging to, and obtaining a number of each of the detects to obtain the plurality of detection data. Each of the display panel corresponds to one of the detection data.

When defects existing on the display panels are detected, the method may further include: obtaining positional information of the defects.

That is, the detection data may further include the positional information of the defects, and for example, the positional information can be the coordinates of the defects.

In an embodiment, each of the detection data relates to identification numbers of the display panels, and the identification numbers of the display panels relate to identification numbers of the fabrication equipment.

For example, categories of the defects includes scrapes and corrosion, and numbers of the detected scrapes from the first display panel to the fifth display panel in the fabrication equipment A are respectively 3, 4, 7, 8, and 6, and the numbers of the detected corrosion from the first display panel to the fifth display panel in the fabrication equipment A are respectively 2, 3, 7, 9, 10.

S202, obtaining a total of setting defects existing on the display panels manufactured by each of the fabrication equipment according to the plurality of detection data.

For example, the setting defects are defects that greatly affects yield of the display panels, and the setting defects herein may include one type of the defects, and may also include a plurality types of the defects. The setting defects being scrapes are taken as an example.

Computing to obtain the total of setting defects exiting on all the display panels of each of the fabrication equipment according to the detection data obtained in the step S101. For example, the fabrication equipment A, which manufactures five display panels, and the total of the scrapes existing on the five display panels in the fabrication equipment A is computed as 28.

The step of obtaining a total of setting defects existing on the display panels manufactured by each of the fabrication equipment according to the plurality of detection data includes:

S2021, obtaining identification numbers of the display panels corresponding to each of the fabrication equipment to obtain a plurality of target identification numbers.

For example, obtaining identification numbers of each of the fabrication equipment, and obtaining identification numbers of the corresponding display panels according to the identification numbers of each of the fabrication equipment. For example, serial numbers of the display panels correspond to the fabrication equipment are from P1 to P5.

S2022, obtaining the detection data corresponding to each of the target identification numbers.

For example, respectively obtaining the detection data corresponding from P1 to P5. The numbers of the scrapes from P1 to P5 display panels are respectively 3, 4, 7, 8, and 6.

S2023, computing a sum of the numbers of the setting defects in the detection data.

For example, respectively computing a sum of the numbers of the scrapes from P1 to P5, that is, a total of the numbers of scrapes from P1 to P5, for example, it is 28.

S203, obtaining a total of the display panels manufactured by each of the fabrication equipment in the preset duration to obtain a panel amount.

For example, the fabrication equipment A manufactures five display panels in the preset duration, that is the panel amount is five.

S204, judging whether the exception occurring on the fabrication equipment according to the total of the setting defects and the panel amount.

For example, judging whether the exception occurring on the fabrication equipment according to the total of the scrapes of each of the fabrication equipment and the panel amount.

In an embodiment, in order to improve accuracy of detection, the step of judging whether the exception occurring on the fabrication equipment according to the total of the setting defects and the panel amount includes the total of each defect.

S2041, obtaining a ratio between the total of the setting defects and the panel amount.

S2042, when the ratio is greater than a preset threshold value, the exception occurring on the fabrication equipment is determined.

For example, respectively obtaining a ratio between the total of the scrapes and the panel amount of the fabrication equipment. For example, the ratio is 5.6 from 28 divided by 5, then judging whether the ratio is greater than a preset threshold value. If the ratio is greater than the preset threshold value, then the exception occurring on the fabrication equipment is determined. The preset threshold value can be configured according to values from experiences.

It can be understood that if the setting defects are various, when one of the ratios is greater than the preset threshold value, the exception occurring on the fabrication equipment is determined.

S205, if the exception occurs on the fabrication equipment, performing exception handling on the fabrication equipment.

For example, when the exception occurring on the fabrication equipment A is determined, the fabrication equipment can be turned off, or the fabrication equipment can be controlled to intercept the display panel being manufactured currently.

Based on the previous embodiment, because this embodiment judges the exception according to the numbers of the setting defects, the judging process has been simplified. Therefore, detection efficiency is improved, and production efficiency is further improved.

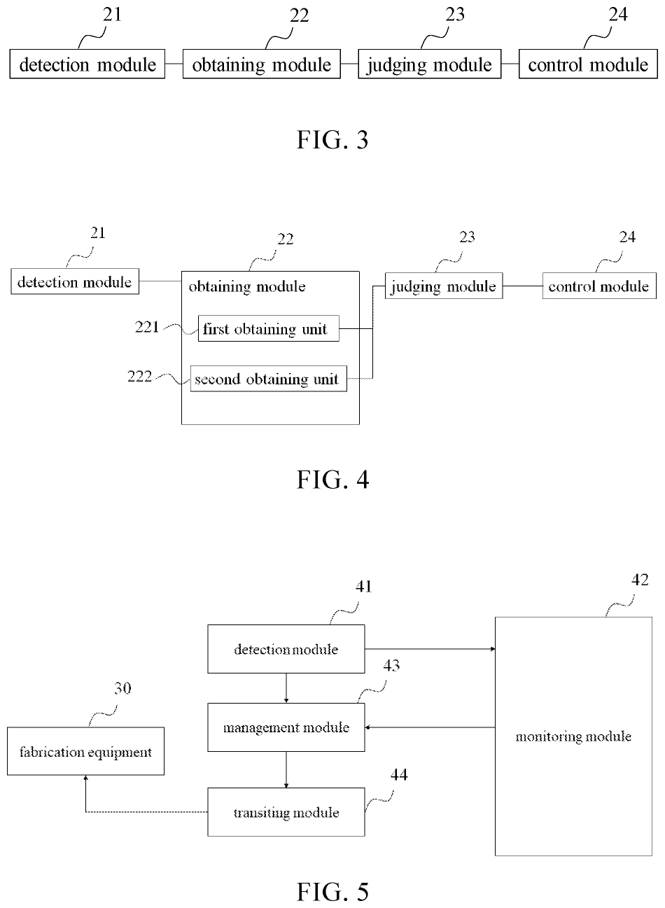

The present disclosure further provides a control device of fabrication equipment. As illustrated in FIG. 3 and FIG. 4, the device includes a detection module 21, an obtaining module 22, a judging module 23, and a control module 24.

The detection module 21 is used for detecting each display panel manufactured by each of the fabrication equipment in a preset duration. When defects existing on the display panels are detected, determining a category of the defects belonging to, and obtaining a number of each of the detects to obtain a plurality of detection data. Each of the display panel corresponds to one of the detection data.

The obtaining module 22 is used for obtaining a total of each of the defects existing on the display panels of each of the fabrication equipment according to the plurality of detection data.

The judging module 23 is used for judging whether an exception occurring on the fabrication equipment according to the total of each defect.

The control module 24 is used for performing exception handling on the fabrication equipment when the exception occurs on the fabrication equipment.

In an embodiment, the obtaining module 22 includes:

A first obtaining unit 221, which is used for obtaining a total of setting defects existing on the display panels manufactured by each of the fabrication equipment according to the plurality of detection data.

A second obtaining unit 222, which is used for obtaining a total of the display panels manufactured by each of the fabrication equipment in the preset duration to obtain a panel amount.

The judging module 23, which is specifically used for judging whether the exception occurring on the fabrication equipment according to the total of the setting defects and the panel amount.

In an embodiment, the judging module 23 is specifically used for obtaining a ratio between the total of the setting defects and the panel amount. When the ratio is greater than a preset threshold value, the exception occurring on the fabrication equipment is determined.

Furthermore, each of the detection data relates to identification numbers of the display panels, and the identification numbers of the display panels relate to identification numbers of the fabrication equipment.

The obtaining module 22 is specifically used for obtaining identification numbers of the display panels corresponding to each of the fabrication equipment to obtain a plurality of target identification numbers, and the obtaining module 22 is used for obtaining the detection data corresponding to each of the target identification numbers, and computing a sum of the numbers of each defect in the detection data.

When defects existing on the display panels are detected, the detection module 21 is further used for obtaining positional information of the defects.

In an embodiment, if the exception occurs on the fabrication equipment, the control module 24 is specifically used for turning off the fabrication equipment or for controlling the fabrication equipment to intercept the display panel being manufactured currently.

For example, in a specific embodiment, as illustrated in FIG. 5, the detection module 41 detects each display panel manufactured by the fabrication equipment 30. When defects are detected, obtaining coordinates of the detects and determining the category of the detects and the number of the setting defects to obtain the detection data, and after relating the detection data to identification numbers of the display panels, sending the detection data to a monitoring module 42. The monitoring module 42 obtains the total of the setting defects of the fabrication equipment 30 and the total of the display panels manufactured by each fabrication equipment in the preset duration, then computes a ratio of the two, and judges whether the ratio is greater than the preset threshold value. If the ratio is greater than the preset threshold value, and the monitoring module 42 determines the exception occurs on the fabrication equipment 30, then the monitoring module 42 generates an exception processing instruction, and sends it to a management module 43.

Furthermore, a delay time can be configured on the monitoring module 42. The exception can be analyzed in the delay time to judge whether it is necessary to actually send instruction for intercepting the panels or turning off the equipment. If it is not the exception, sending this message can be canceled.

When the management module 43 receives the exception processing instruction sent from the monitoring module 42, the management module 43 converts the message and then sends the message to a transiting module 44. The transiting module 44 directly sends instruction to the fabrication equipment 30 to intercept the panel produced abnormally to prevent it going into a following process, or the transiting module 44 directly turns off the fabrication equipment 30 for monitoring and repairing by engineers.

The control device of the fabrication equipment of the present disclosure includes: when defects existing on the display panels are detected, determining a category of the defects belonging to, and obtaining a number of each of the detects to obtain a plurality of detection data; obtaining a total of each of the defects existing on the display panels manufactured by each fabrication equipment according to the plurality of detection data; judging whether an exception occurring on the fabrication equipment according to the total of each defect. If the exception occurs on the fabrication equipment, performing exception handling on the fabrication equipment. Because the present disclosure can detect the fabrication equipment having the exception automatedly, it can prevent from waste of material. When the equipment is abnormal, it is turned off, or the display panel is intercepted, thereby reducing a scrapping rate of the panels and improving product yield.

In summary, although the present disclosure has disclosed the preferred embodiments as above, however the above-mentioned preferred embodiments are not to limit to the present disclosure. A person skilled in the art can make any change and modification, therefore the scope of protection of the present disclosure is subject to the scope defined by the claims.

What is claimed is:

1. A control method of fabrication equipment, comprising:
detecting each display panel manufactured by each of the fabrication equipment in a preset duration, when defects existing on the display panels are detected, determining a category of the defects belonging to, and obtaining a number of each of the detects to obtain a plurality of detection data, wherein each of the display panel corresponds to one of the detection data,
obtaining a total of setting defects existing on the display panels manufactured by each of the fabrication equipment according to the plurality of detection data;
obtaining a total of the display panels manufactured by each of the fabrication equipment in the preset duration to obtain a panel amount;
judging whether an exception occurring on the fabrication equipment according to the total of the setting defects and the panel amount; and
if the exception occurs on the fabrication equipment, turning off the fabrication equipment, or the fabrication equipment can be controlled to intercept the display panel being manufactured currently.

2. The control method of the fabrication equipment as claimed in claim 1, wherein steps of judging whether the exception occurring on the fabrication equipment according to the total of the setting defects and the panel amount comprise:
obtaining a ratio between the total of the setting defects and the panel amount; and
when the ratio is greater than a preset threshold value, the exception occurring on the fabrication equipment is determined.

3. The control method of the fabrication equipment as claimed in claim 1, wherein each of the detection data relates to identification numbers of the display panels, and the identification numbers of the display panels relate to identification numbers of the fabrication equipment,
the step of obtaining each defect of each display panel of each of the fabrication equipment according to the plurality of detection data comprises:
obtaining identification numbers of the display panels corresponding to each of the fabrication equipment to obtain a plurality of target identification numbers;
obtaining the detection data corresponding to each of the target identification numbers; and
computing a sum of the numbers of each defect in the detection data.

4. The control method of the fabrication equipment as claimed in claim 1, wherein when the defects exist on the display panels, the method comprises:
obtaining positional information of the defects.

5. A control method of fabrication equipment, comprising:
detecting each display panel manufactured by each of the fabrication equipment in a preset duration, when defects existing on the display panels are detected, determining a category of the defects belonging to, and obtaining a number of each of the detects to obtain a plurality of detection data, and each of the display panel corresponds to one of the detection data,
obtaining a total of each of the defects existing on the display panels manufactured by each of the fabrication equipment according to the plurality of detection data;
judging whether an exception occurring on the fabrication equipment according to the total of each defect; and
if the exception occurs on the fabrication equipment, performing exception handling on the fabrication equipment.

6. The control method of the fabrication equipment as claimed in claim 5, wherein the step of obtaining the total of each defect exiting on the display panels manufactured by each of the fabrication equipment according to the plurality of detection data comprises:
obtaining a total of setting defects existing on the display panels manufactured by each of the fabrication equipment according to the plurality of detection data;
obtaining a total of the display panels manufactured by each of the fabrication equipment in the preset duration to obtain a panel amount;
the step of judging whether the exception occurring on the fabrication equipment according to the total of each defect comprises:
judging whether the exception occurring on the fabrication equipment according to the total of the setting defects and the panel amount.

7. The control method of the fabrication equipment as claimed in claim 6, wherein steps of judging whether the exception occurring on the fabrication equipment according to the total of the setting defects and the panel amount comprise:
obtaining a ratio between the total of the setting defects and the panel amount; and
when the ratio is greater than a preset threshold value, the exception occurring on the fabrication equipment is determined.

8. The control method of the fabrication equipment as claimed in claim 5, wherein each of the detection data relates to identification numbers of the display panels, and the identification numbers of the display panels relate to identification numbers of the fabrication equipment,
the step of obtaining each defect of each display panel of each of the fabrication equipment according to the plurality of detection data comprises:
obtaining identification numbers of the display panels corresponding to each of the fabrication equipment to obtain a plurality of target identification numbers;
obtaining the detection data corresponding to each of the target identification numbers; and
computing a sum of the numbers of each defect in the detection data.

9. The control method of the fabrication equipment as claimed in claim 5, wherein when the defects exist on the display panel, the method comprises:
obtaining positional information of the defects.

10. The control method of the fabrication equipment as claimed in claim 5, wherein the step of performing the exception handling on the fabrication equipment comprises:
turning off the fabrication equipment or controlling the fabrication equipment to intercept the display panel being manufactured currently.

11. A control device of fabrication equipment, comprising:
a detection module used for detecting each display panel manufactured by each of the fabrication equipment in a preset duration, when defects existing on the display panels are detected, determining a category of the defects belonging to, and obtaining a number of each of the detects to obtain a plurality of detection data, and each of the display panel corresponds to one of the detection data,
an obtaining module used for obtaining a total of each of the defects existing on the display panels manufactured by each of the fabrication equipment according to the plurality of detection data;
a judging module used for judging whether an exception occurring on the fabrication equipment according to the total of each defect; and
a control module used for performing exception handling on the fabrication equipment when the exception occurs on the fabrication equipment.

12. The control device of the fabrication equipment as claimed in claim 11, wherein the obtaining module comprises:
a first obtaining unit used for obtaining a total of setting defects existing on the display panels manufactured by each of the fabrication equipment according to the plurality of detection data;
a second obtaining unit used for obtaining a total of the display panels manufactured by each of the fabrication equipment in the preset duration to obtain a panel amount;
the judging module is used for judging whether the exception occurring on the fabrication equipment according to the total of the setting defects and the panel amount.

13. The control device of the fabrication equipment as claimed in claim 12, wherein the judging module is used for obtaining a ratio between the total of the setting defects and the panel amount, and when the ratio is greater than a preset threshold value, the exception occurring on the fabrication equipment is determined.

14. The control device of the fabrication equipment as claimed in claim 11, wherein each of the detection data relates to identification numbers of the display panels, and the identification numbers of the display panels relate to identification numbers of the fabrication equipment,
the obtaining module is used for obtaining identification numbers of the display panels corresponding to each of the fabrication equipment to obtain a plurality of target identification numbers, and the obtaining module is used for obtaining the detection data corresponding to each of the target identification numbers, and computing a sum of the numbers of each defect in the detection data.

15. The control device of the fabrication equipment as claimed in claim 11, wherein the detection module is used for obtaining positional information of the defects when defects existing on the display panels are detected.

16. The control device of the fabrication equipment as claimed in claim 11, wherein the control module is used for turning off the fabrication equipment or controlling the fabrication equipment to intercept the display panel being manufactured currently.
